(19) United States
(12) Patent Application Publication
(10) Pub. No.: US 2022/0156633 A1
(43) Pub. Date: May 19, 2022

(54) SYSTEM AND METHOD FOR ADAPTIVE COMPRESSION IN FEDERATED LEARNING

(71) Applicant: Kabushiki Kaisha Toshiba, Tokyo (JP)

(72) Inventors: Saif ANWAR, Bristol (GB); Pietro E. CARNELLI, Bristol (GB); Aftab KHAN, Bristol (GB)

(73) Assignee: Kabushiki Kaisha Toshiba, Tokyo (JP)

(21) Appl. No.: 16/952,705

(22) Filed: Nov. 19, 2020

(51) Int. Cl. G06N 20/00; H04L 29/08; H04L 29/06

(52) U.S. Cl. CPC G06N 20/00; G06N 3/082; H04L 65/80; H04L 67/10

(57) ABSTRACT

A computer-implemented method for training a machine learning model in a distributed system, the distributed system comprising a plurality of nodes that exchange updates to communally train the machine learning model. The method comprises a node: receiving an update to a local model from one or more other nodes in the distributed system, the local model being a locally maintained version of the machine learning model and the update specifying a change to one or more parameters of the local model; updating the local model based on the received update to determine an updated local model; determining for each parameter in the local model a change in the parameter relative to a previous version of the local model; and sending an update to the one or more other nodes in the distributed system, wherein the update includes an update to each parameter that has a change greater than a threshold.

### TECHNICAL FIELD

The present disclosure relates to methods and systems for training a machine learning model in a distributed system. In particular, but without limitation, this disclosure relates to methods of performing federated learning efficiently by optimizing the size of updates shared between devices within the system according to model and/or network performance.

### BACKGROUND

Machine Learning (ML) methods aim to train a model based on observed data. In traditional ML approaches, raw data collected by edge devices (such as within an internet of things, IoT, network) is communicated back to a central server in order to train a global model.

Federated Learning (FL) and Distributed Learning (DL) are decentralised ML frameworks that aim to parallelise the training process using multiple connected computer devices simultaneously, to train a single model. Edge devices are pieces of hardware in a network (e.g. in the IoT) that provide an entry point to the network and that can constantly collect raw data. In some scenarios, IoT devices may be limited in terms of network quality. In these cases, communication will need to be restricted further to allow for consistent training.

Deep learning is a subset of ML where large datasets are used to train ML models in the form of neural networks (NNs). A neural network is a connected system of functions whose structure is inspired by the human brain. Multiple nodes are interconnected with each connection able to transmit data like signals transmitted via synapses. Connections between nodes carry weights which are the parameters being optimised, consequently training the model.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a system architecture for implementing federated learning according an arrangement;

FIG. 2 shows a an example of a cycle of full updates across a number of workers according to an implementation;

FIG. 3 shows a flowchart detailing a federated learning method with a fixed update size from workers and full global updates from the server;

FIG. 4 shows a method for federated learning with adaptive update size according to an implementation;

FIGS. 5-7 show plots of different performance metrics for different update methods and for various bandwidths;

FIG. 8 shows the total data communicated for different update methods at different communication bandwidths before converging to a stable model;

FIG. 9 shows the total time taken for different update methods at different communication bandwidths before converging to a stable model; and

FIG. 10 shows a computing device for putting the methods described herein into practice.

### DETAILED DESCRIPTION

Implementations described herein provide improvements to federated learning by adapting the size of each update sent between nodes within a distributed system based on the current stability of the model (based on the change in parameters between each iteration of the model). This reduces the transmission of less important updates (parameters that are not changing greatly). This increases the efficiency of network usage, without unduly affecting training performance. Further specific implementations adapt the size of each update based on the quality of service (e.g. throughput) of the communication link over which the update is to be sent. This makes efficient use of network capacity, allowing larger updates to be sent when throughput is higher to improve training performance, and reducing update size to maintain a consistent rate of updates when throughput is lower.

According to an aspect of the present disclosure there is provided a computer-implemented method for training a machine learning model in a distributed system, the distributed system comprising a plurality of nodes that exchange updates to communally train the machine learning model. The method comprises a node: receiving an update to a local model from one or more other nodes in the distributed system, the local model being a locally maintained version of the machine learning model and the update specifying a change to one or more parameters of the local model; updating the local model based on the received update to determine an updated local model; determining for each parameter in the local model a change in the parameter relative to a previous version of the local model; and sending an update to the one or more other nodes in the distributed system, wherein the update includes an update to each parameter that has a change greater than a threshold.

By setting a threshold for each update, wherein each update includes an update to each parameter that has a change greater than a threshold, the size of each update can be adjusted based on model stability. Larger updates are sent when the model is undergoing a larger change in parameters, and smaller updates are sent when the model is changing less significantly. As the importance of each update is dependent on the relative change in parameters, this helps adapt the size of each update to its relative impact on the machine learning model.

Each update may include only the parameters that have changed greater than the threshold. Parameters that do not have a change greater than the threshold may be excluded from the update. The update may also include identifiers identifying the one or more parameters to which the update applies.

For each parameter included in the update (i.e. for each parameter that has a change greater than the threshold), the update may include the updated parameter and/or the change (gradient) in the parameter.

In one implementation, the method further comprises: monitoring a quality of service of a communication link between the node and the one or more other nodes; and adjusting the threshold based on the quality of service. Quality of service may be represented by any number of parameters, including throughput, bandwidth, signal to noise ratio, channel quality, received signal strength, error rate or network availability.

According to an implementation, adjusting the threshold based on the quality of service comprises: increasing the threshold in response to the quality of service increasing; and decreasing the threshold in response to the quality of service decreasing.

According to an implementation, monitoring the quality of service comprises monitoring a throughput of the communication link. The quality of service increases when the throughput increases and the quality of service decreases when the throughput decreases.

According to an implementation, the threshold is adjusted within a specified range that defines at least a maximum permissible threshold. This allows a minimum update size to be set to ensure that updates are still sent, even if the parameters are only changing by a small amount.

According to an implementation, adjusting the threshold based on the quality of service comprises adjusting the threshold to ensure a maximum transmission size for the update according to a current bandwidth of the communication link. For instance, the maximum transmission size may be a function of (e.g. may be directly proportional to) the current bandwidth or throughput.

According to an implementation, the change is a percentage change relative to a previous version of the parameter. The percentage may be represented either as a ratio or out of 100 (e.g. 0.5 or 50%).

According to an implementation, the plurality of nodes comprises a plurality of workers and a server, wherein: each of the plurality of workers is configured to train a respective local model and report updates to the local model back to the server; and the server is configured to aggregate updates from the workers to maintain a global model and report updates to the global model back to the workers.

The methods described herein may be implemented in any of the nodes, for instance, in one of the workers or in the server. In addition, one node may function as both a worker and a server. When updates are being sent from the server to a plurality of workers, each update to a worker may be based on the quality of service (e.g. throughput) of the communication link to that specific worker.

According to an implementation, the node is a worker and the update to the local model is received from the server and represents an update to the global model. Updating the local model comprises: applying the update to the local model to bring the local model into compliance with the global model; and training the local model based on training data to obtain the updated local model comprising updated parameters. The update is sent by the worker to the server for use in updating the global model.

According to an implementation, the node is the server and the local model maintained by the node is the global model that is locally maintained by the server. Receiving an update to a local model comprises receiving a plurality of updates from the plurality of workers, each update representing an update to a corresponding local model for the corresponding worker. Updating the local model comprises aggregating the updates from the plurality of workers to update the global model. The update is sent by the server to each of the workers for use in updating their respective local models.

According to an implementation, the method further comprises the server periodically sending a full update of the global model representing the current state of every parameter of the global model to each of the workers. This enables the workers to be kept updated periodically with the full global model to avoid large divergences in training.

According to an implementation, for each update that is sent by the server to a worker, the server determines whether to send a full update or an update including only those parameters that have changed by more than the threshold based on whether the worker has received a full update within a predefined period.

According to an implementation, the server implements a cyclic update strategy wherein each worker has a predefined allocation of full updates within each cycle. The predefined allocation may be any positive integer (e.g. one, two, three, etc.).

According to an implementation, the predefined allocation is one and after a full update has been sent to a worker within a cycle, another full update is not sent until every other worker has received at least one full update within the cycle.

According to a further aspect of the present disclosure there is provided a node for use in a distributed system comprising a plurality of nodes that exchange updates to communally train a machine learning model, the node comprising: storage configured to store a local model the local model being a locally maintained version of the machine learning model; and a processor. The processor is configured to: receive an update to a local model from one or more other nodes in the distributed system, the local model being a locally maintained version of the machine learning model and the update specifying a change to one or more parameters of the local model; update the local model based on the received update to determine an updated local model; determine for each parameter in the local model a change in the parameter relative to a previous version of the local model; and send an update to the one or more other nodes in the distributed system, wherein the update includes an update to each parameter that has a change greater than a threshold.

According to a further aspect of the present disclosure there is provided a non-transitory computer-readable medium comprising computer executable instructions that, when executed by a computer, configure the computer to act as a node within a distributed system, the distributed system comprising a plurality of nodes that exchange updates to communally train a machine learning model. The computer executable instructions cause the computer to: receive an update to a local model from one or more other nodes in the distributed system, the local model being a locally maintained version of the machine learning model and the update specifying a change to one or more parameters of the local model; update the local model based on the received update to determine an updated local model; determine for each parameter in the local model a change in the parameter relative to a previous version of the local model; and send an update to the one or more other nodes in the distributed system, wherein the update includes an update to each parameter that has a change greater than a threshold.

In light of the above, implementations provide a mechanism for adapting the size of updates between nodes in a distributed system to make more efficient use of network capacity. Specific implementations of the present disclosure are described below.

The increase in computing power of edge devices (e.g. in IoT networks) has allowed the Federated Learning (FL) training process to be moved from the cloud to the edge. In turn, this allows fewer instances of raw data transmission (since in FL, worker nodes typically train on data collected locally to the device) across the network, but an increase in the sharing of FL model parameters.

Large ML models typically require the precise tuning of billions of parameters/weights. By implementing training on the edge of a network, data transmission across the network can be reduced. Furthermore, training data can be kept at the edges of the network, thereby improving privacy in situations where the training data is sensitive (for instance, private data relating to individual users).

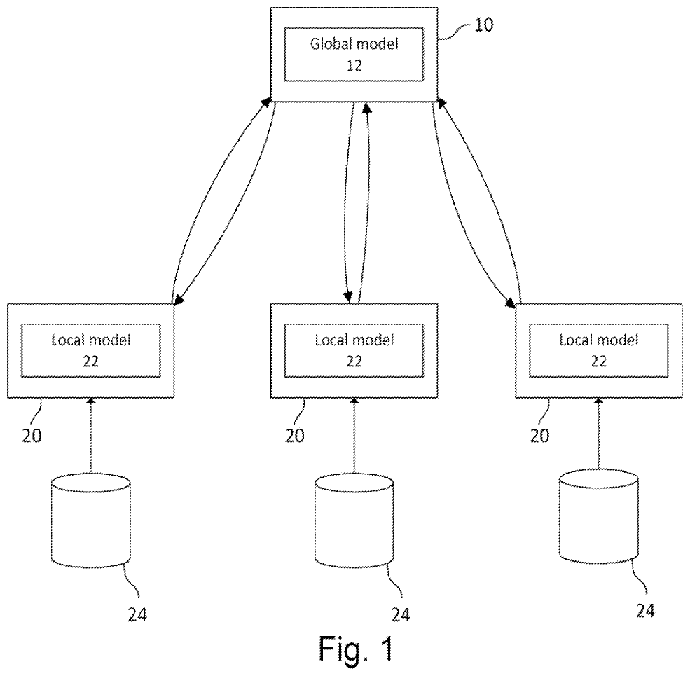

FIG. 1 shows a system architecture for implementing federated learning according an arrangement. The system architecture contains a Parameter Server (PS) node 10 and multiple worker nodes 20. A global model 12 is stored at the PS 10. Worker nodes 20 contribute to training the global model 12. In this architecture, workers 20 ‘push’ model updates to the PS 10. These updates are aggregated at the PS to update the global model 12. The parameters of the updated global are then communicated back to each worker 20.

More specifically, each worker node stores a local model 22. This local model 22 is a locally maintained version of the global model 12. The local model 22 can be randomly initialised, but generally each local model 22 is periodically updated to match the global model 12 based on updates transmitted from the parameter server 10 to the workers 20.

Each worker 20 trains the local model 22 based on locally available training data 24. This training data 24 may be unique to the respective worker node 20 and may either be stored in memory (e.g. from earlier measurements) or may be received in real time (e.g. from sensor readings).

Each worker 20 can train the local model 22 through one or more updates to the local model 22 based on the training data. In general, training involves adjusting the parameters (the weights) of the neural network to optimise some function (e.g. to reduce the error). Gradient Descent (GD) is one optimisation approach for learning weights of a NN, although other methods for parameter optimization are available.

After training the local models, the workers 20 communicate parameter updates to the parameter server 10 which aggregates the parameter updates across the workers 20 and applies this to update the global model 12.

The parameter updates reported back to the parameter server 10 can include gradients (e.g. a difference between an updated parameter of the local model 22 and the previous corresponding parameter of the global model 12) or can be updated parameters of the local model 22 which can then be used by the parameter server 10 to determine updates to the global model 12. Aggregation of the updates could be in the form of taking an average (e.g. mean or median) across the updates, or may be through any other form of aggregation.

Once the global model 12 has been updated, the parameters of the updated global model 12 can be communicated back to the workers 20 to allow them to update their respective local models 22.

Updates may be exchanged after each step of training on the local models, or multiple training steps may be performed before the global model is updated. Updating the global model after each step of local model training is advantageous in that it ensures that the local models do not diverge from each other. Equally, updating after a few optimisation iterations can reduce the number of updates that need to be transferred.

Each iteration of updating the global model 12 includes the transition of updates from the workers 20 to the PS 10 and the transition of the updated parameters of the global model back to the workers 20. The communication of large amounts of data through the network is therefore a major bottleneck in large scale FL model training. In potential applications, devices may be limited in terms of permitted energy usage, communication bandwidth (BW) and other network resources. This would hinder participation in FL model training, as the network quality of service would be insufficient to withstand such quantities/rates of data transfer. It is of interest to keep these FL workers/nodes/agents connected and ensure they are still able to engage in the training process.

It should be noted that whilst the present implementation has a separate server to the workers, the server may also be a worker and therefore may also perform local training either directly on the global model or as an emulated worker that updates a separate local version and aggregates its own updates with updates from other workers.

The present application proposes a novel adaptive federated learning model parameter compression method to reduce the overall amount of data transmitted during the training phase of a distributed system. Furthermore, the parameter compression method introduced herein is able adapt to changing environments of varying network quality of service or architectures.

Compression normally refers to the act of decreasing storage size of a set of data whilst maintaining the information. Conversely, NN pruning can be described as the elimination or replacement of non-essential components of a model. This way, the size of the model can be reduced without compromising the performance. Existing pruning strategies have been titled under the label of compression. The strategy developed in this application will conform to the definition of NN pruning however, for ease of comparison, will also be referred to as compression, as it reduces the size of the NN updates whilst maintaining performance.

It is possible to specify a percentage of parameters to push upon each iteration as an update to reduce the amount of data transferred across the network. Having said this, applying a set percentage does not allow for model performance or network quality to be taken into account.

Based on the intuition that parameters do not change drastically between training iterations, the present application proposes an Adaptive Compression (AC) method, which exploits the status of parameter changes to reduce update sizes.

Implementations of the AC method use the observed network quality of the communication channel between a worker and the PS. From this, the AC method aims to maintain a consistent update rate by reducing the update size so that channels with lower available bandwidth can communicate updates more frequently and quickly.

Network quality can be defined in terms of a number of different metrics, such as throughput, bandwidth, signal to noise ratio, channel quality, received signal strength, error rate, network availability, etc. These can be measured with respect to the communication link over which the update is to be sent.

To adapt to model stability, each update only contains parameters that have changed by a certain threshold between consecutive updates. For the full set of model parameters w(θ) at iteration θ, each parameter wₗ(θ) will be included in the compressed set of parameters if the following condition is satisfied:

$$\vert \frac{{w}_{i} ( θ ) - {w}_{i} ( θ + 1 )}{{w}_{i} ( θ )} \vert \geq α$$

where α is a difference threshold required of a parameter between consecutive iterations. That is, a parameter is included in an update if the relative change in the size of the model parameter since the previous iteration is greater than the difference threshold α.

As each update includes only a fraction of the full set of model parameters, each update will also include the identifiers for the updates (e.g. the indices for the relevant parameter weights) to enable the receiving device to determine which parameters the updates relate to. As mentioned previously, each update may specify either the update parameter or the gradient for the updated parameter.

Applying a set threshold on parameter change allows the update sizes to be adapted based on model stability. That is, smaller updates are sent when the model is stable (and therefore not changing significantly) whilst larger updates are sent when the model is learning quickly. This means that the size of the updates is scaled based on the relative information learnt on each update. This therefore avoids the inefficient transfer of updates for only slight changes in parameters.

The difference threshold a need not be fixed and can be adapted based on the observed network quality. Where network quality is high (e.g. high bandwidth or throughput), the difference threshold can be set low, e.g. to make use of additional bandwidth. Setting a low threshold means that larger updates are sent, as more parameters will have a change that exceeds the threshold. Conversely, where the network quality is low (e.g. low bandwidth or throughput), the difference threshold can be set high to maintain a regular rate of updates. Setting a high threshold reduces the size of the updates, thereby allowing more regular updates to be sent when throughput is lower.

The difference threshold can therefore be continuously monitored to ensure update sizes do not become too large and slow down training. Other factors can also be taken into account, such as model quality, where if the observed model quality is lower than expected then the threshold can be lowered to allow for fuller, less compressed updates, or battery life, where update sizes can be reduced when device battery life is low (e.g. below a threshold) to help to conserve power.

In addition, a maximum threshold can be set to avoid the threshold becoming too large and blocking further updates. If the threshold is too large, then no parameters may be updated, or each update may include too few parameters for successful training. Accordingly, whilst the threshold may be adapted, maximum and/or minimum values for the threshold may be set to ensure consistent training.

Alternatively to the threshold method described above, each update may be set to a given size based on the network quality (e.g. based on the bandwidth). The parameters with the largest change may then be included in the update up to the given size for the update.

The parameters for the updates (e.g. the various thresholds or update sizes) may be predetermined for various levels of network quality (e.g. various bandwidths). These may be stored in each device, for instance, in a look-up table.

As well as compressing updates adaptively from workers to the Parameter Server (PS), the same compression strategy can be implemented when distributing the global model from the PS to the workers. Each update to each worker may be based on the quality of service of the communication link from the Parameter Server to that respective worker. Accordingly, different sized updates can be sent to different workers based on varying communication link quality (e.g. based on differing throughput). Having said this, if global model updates are consistently compressed, worker interpretations of the global model will become skewed and training steps will not be as effective as they could be, as it is not training on the same model.

To avoid this, a rotation-based update system can be introduced at the PS to ensure that each worker receives the full global model update periodically. For instance, the rotation-based update system can ensure that each worker will receive a full global model update once per cycle (per rotation), but not again until every other worker has also received a full update. If a worker requests a global model update before the PS has communicated a full update to the rest of the workers, AC is applied, and the worker receives a compressed update.

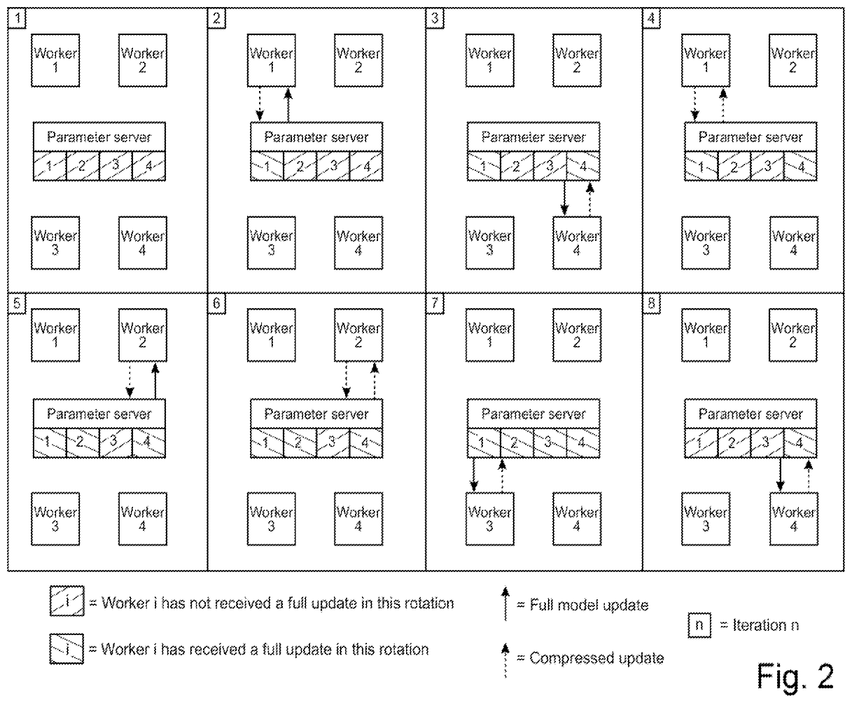

The PS keeps track of which workers have received a full model update since the last time the rotation was completed. When all workers have received a full model in this rotation, the system is reset. With this in place, a worker refreshes its interpretation of the global model occasionally enough such that the effect on the performance is not detrimental. This is illustrated in FIG. 2.

FIG. 2 shows an example of a cycle of full updates across a number of workers according to an implementation. Eight time steps are shown. Each subplot (time step) represents one iteration where a single worker pushes an update to the PS and receives a global model update back of decided size. The order of workers pushing updates is random. Each time a worker pushes an update to the server is an implicit request for an update from the server.

In the first time step, none of the workers have received an update in the cycle. In the second time step, a first worker receives a full update. In the third time step, a fourth worker receives a full update. In the fourth time step, the first worker requests another update. As the first worker has already received a full update in this cycle, the server sends a compressed update to the first worker. In the fifth time step, a second worker receives a full update. In the sixth time step the second worker requests another update, so receives a compressed update. In the seventh time step, the third and final worker receives a full update. This completes the cycle. Accordingly, in the next (eighth) time step, when the fourth worker requests an update it receives a full update.

There need not be any specific order in which the full updates may be provided. In general, the only requirement is that each worker receives at least one full update within a given cycle time.

The order of the rotational update strategy can also be varied to amend frequency of full updates further. Such as, one full update followed by ten compressed updates or alternating full updates with compressed updates. This can be chosen depending on the model and the number of workers to ensure consistent training with limited communication.

The proposed AC method allows for suitable sized updates given any network condition and supports consistent training times with minimal data transferred.

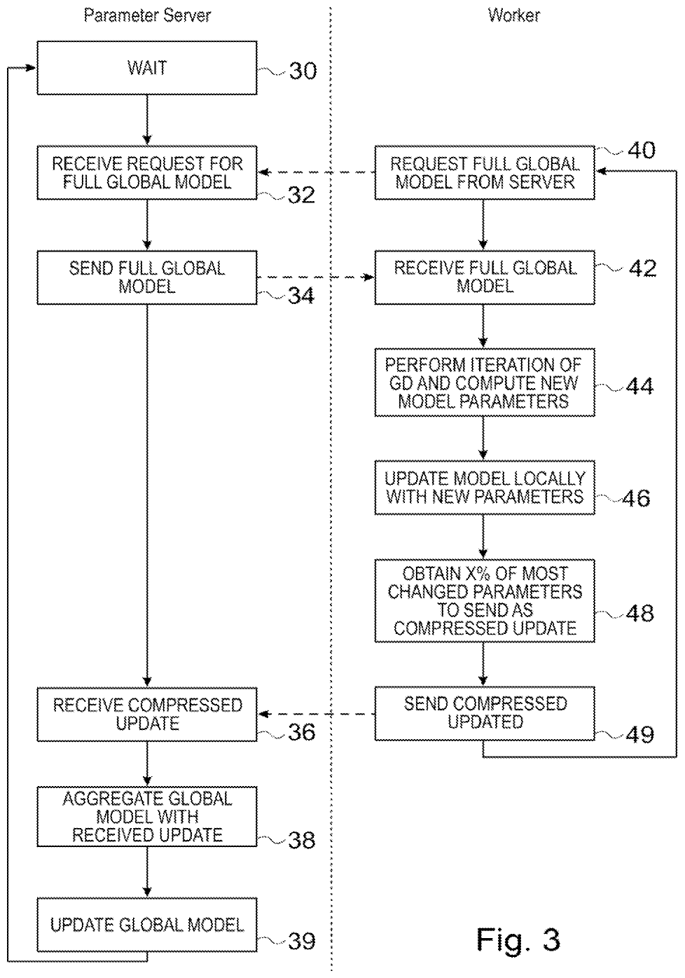

FIG. 3 shows a flowchart detailing a federated learning method with a fixed update size from workers and full global updates from the server. As described above, keeping a fixed update size results in inefficient data exchange and can cause issues with delayed updates due to varying network quality.

Operation for a parameter server and a single worker node is displayed with the dotted line representing a network interface between the two. Solid arrows represent communication within the node (e.g. the respective server or worker) whereas dashed arrows represent communication across the network to the other node.

The method begins with the server waiting 30 for a request from a worker for an update. When an update request is sent by a worker 40 and received 32 by the server then the server sends a full global model is sent 34 to the respective worker.

When the worker receives the full global model 42 it replaces the local model stored at the worker with the global model and performs a training update on the global model 44. This training update adjusts the parameters according to an optimisation method. In the present example, gradient descent is used to update the global model parameters based on training data that is available to the worker. The global model is therefore updated locally to produce new model parameters from the training 46.

The worker then determines a certain proportion (a certain percentage) of the most changed parameters to send as a compressed update 48. For instance, the parameters may be ordered in terms of the relative change (the gradient) and the top X % may be selected. The selected parameters are then sent in an update 49 to the server. The worker then loops back to step 40 to send a request for a further update from the server.

When the server receives the compressed update 36 it aggregates 38 this with other updates from other workers and updates the global model based on the aggregate 39. The server then moves loops back to step 30 to wait for a further request from a worker.

This method puts a large strain on the network as the server reports full updates to each worker and each worker reports a set percentage of the updated parameters back to the server regardless of model or network conditions. Accordingly, as described earlier, the methodology proposed herein instead adapts update size based on model and network status.

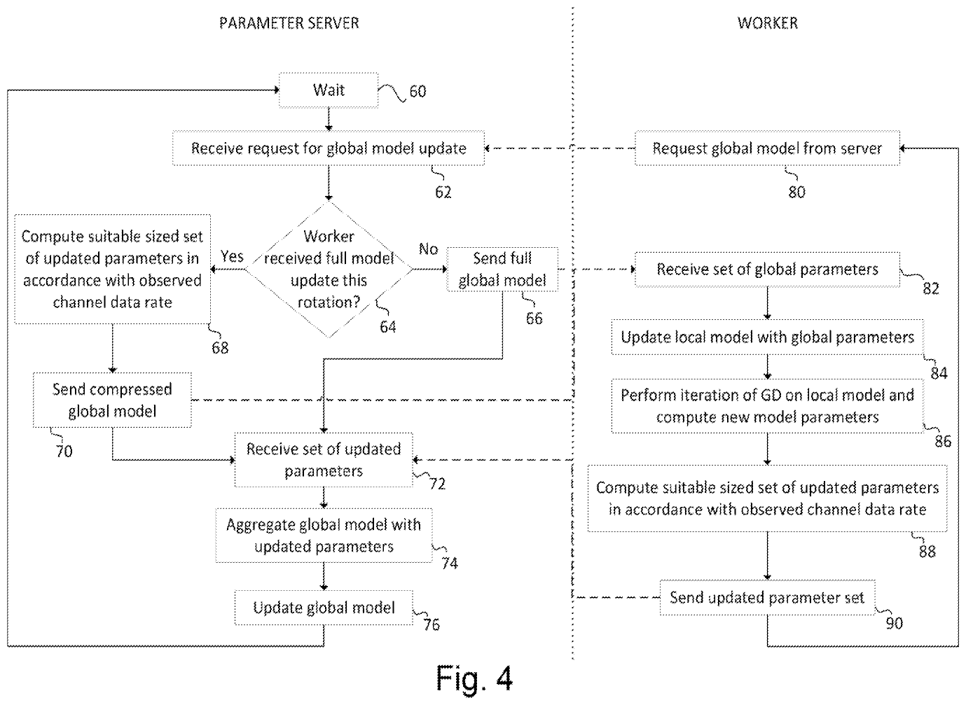

FIG. 4 shows a method for federated learning with adaptive update size according to an implementation. The methodology is similar to that of FIG. 3; however, the server sends compressed updates if a given worker has already received a full model within the current cycle. Furthermore, each worker sends compressed updates of variable size based on the relative change in the parameters.

As with FIG. 3, operation for a parameter server and a single worker node is displayed with the dotted line representing a network interface between the two. Solid arrows represent communication within the node (e.g. the respective server or worker) whereas dashed arrows represent communication across the network to the other node.

The server starts by waiting 60 for a request 80 from a worker. When a request for a global model update is received by the server 62, the server determines whether the requesting worker has received a full update in this cycle 64 (e.g. within a predefined period of time). If not, then the full global model (including all model parameters) is sent to the worker 66. If a full model has been received by the worker this cycle, then a compressed/reduced update is sent.

To send a compressed update, the server computes a suitable sized set of updated parameters in accordance with the current observed channel data rate 68. As described above, this can be based on the relative change in each parameter and based on an adaptive threshold that changes with changing network conditions (e.g. bandwidth/throughput). The selected subset of parameters are then sent 70 to the worker.

When the worker receives the updated parameters 82 (either as a full update or compressed update), the local model is updated 84 based on the received global parameters. Where a full update has been received then the local model is replaced with the global model. Where a compressed update has been received, then only the updated parameters are adjusted.

The worker then performs a training update on the local model 86. This training update adjusts the parameters according to an optimisation method. In the present implementation, gradient descent is used to update the local model parameters based on training data that is available to the worker. The local model is therefore updated locally to produce new model parameters from the training.

The worker then determines a suitable sized set of updated parameters in accordance with the observed channel data rate 88. This is calculated as discussed above based on the relative change in the parameters and with an adjustable threshold based on network quality. The selected parameters are then sent to the server as a compressed update 90. The worker then loops back to step 80 to request another update from the server.

When the server receives 72 the updated set of parameters from the worker, it aggregates the updates from the worker with other worker updates 74. This can be by taking an average (e.g. mean or median) of all updates, although other aggregation methods are available. The global model is then updated 76 based on the aggregated update and the server loops back to step 60 to await another request for an update.

In light of the above, the server adapts whether it sends compressed or full updates based on the update history for the respective worker, to ensure that each worker is receives a full update within a certain cycle time. Furthermore, the size of each update is varied based on the size of the gradients and the current network quality. This provides efficient use of network resources, and ensures a regular rate of updates even with reduced network capacity.

In the implementation of FIG. 4, each update includes updated values for at least a subset of parameters. Alternatively to sending updated values, gradients for the selected parameters could be sent.

As discussed above, the improvements described herein provide efficiencies in federated learning, particularly where network bandwidth is limited or variable.

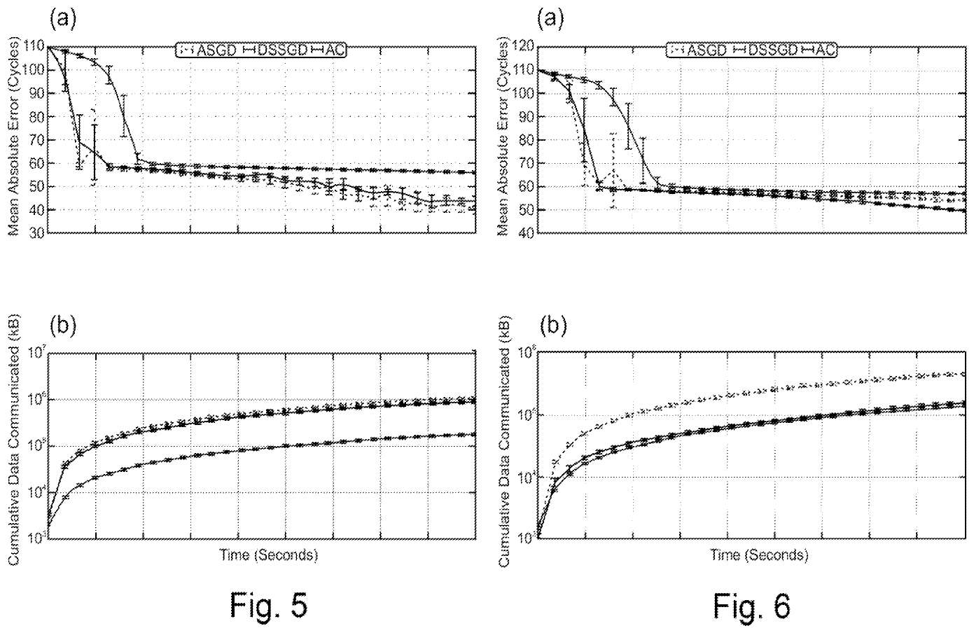

FIGS. 5-7 show plots of different performance metrics for different update methods and for various bandwidths. The plots show metrics for Asynchronous Stochastic Gradient Descent (ASGD), Distributed Selective Stochastic Gradient Descent (DSSGD) and Adaptive Compression (AC), the latter being in accordance with the implementations described herein.

ASGD is described in Asynchronous stochastic gradient descent for DNN training by Zhang, S., Zhang, C., You, Z., Zheng, R., & Xu, B., (2013), ICASSP, IEEE International Conference on Acoustics, Speech and Signal Processing—Proceedings. DSSGD is described in Privacy-preserving deep learning by Shokri, R., & Shmatikov, V. (2015), in Proceedings of the ACM Conference on Computer and Communications Security (Vol. 2015-October, pp. 1310-1321), Association for Computing Machinery.

The dataset used to test the proposed method was the PHMO8 challenge dataset collated by NASA. This dataset contains multiple sets of time series data containing attributes of turbofan engines simulated to experience degradation. Each time series is representative of a different engine. However, engines are assumed to be from a fleet of the same type.

Each engine starts with different levels of wear which is unknown to the user. There are operational setting attributes within the dataset which contribute to performance of the engine. These data are contaminated with noise. Each time series contains 26 attributes in columns with each row containing a value for all attributes for a single cycle.

At the start of the data set each engine is operating normally but at some point in the time series begins to degrade. In the training dataset, this degradation grows until it reaches a predefined threshold such that after this point, operation of the engine is not preferable. The test set contains time series which end sometime before the engine reaches the point of degradation where it should not operate.

The objective of the ML model is to predict the remaining number of cycles once the test set ends that the engine can operate normally before reaching complete degradation. This is called the remaining useful life (RUL) and is measured in cycles.

The performance of the ASGD, DSSGD and AC methods at modelling this dataset were tested for varying bandwidths.

FIG. 5 details metrics for a bandwidth of 1280 kBps. FIG. 6 details metrics for a bandwidth of 320 kBps. FIG. 7 shows metrics for a bandwidth of 80 kBps. All subplots share the same x-axis, indicating time. Each of FIGS. 5-7 detail: (a) the accuracy of the global model recorded by the supervisor; and (b) the total amount of data communicated through the entire network as recorded by the PS.

As can be seen, the amount of data communicated for ASGD and DSSGD is relatively constant with varying bandwidth, whereas the AC system reduces data throughput to adapt to reducing bandwidth. The AC system is also accurate, having a mean absolute error that is less than the DSSGD system for all bandwidths and that generally matches, if not improves upon, the ASGD system.

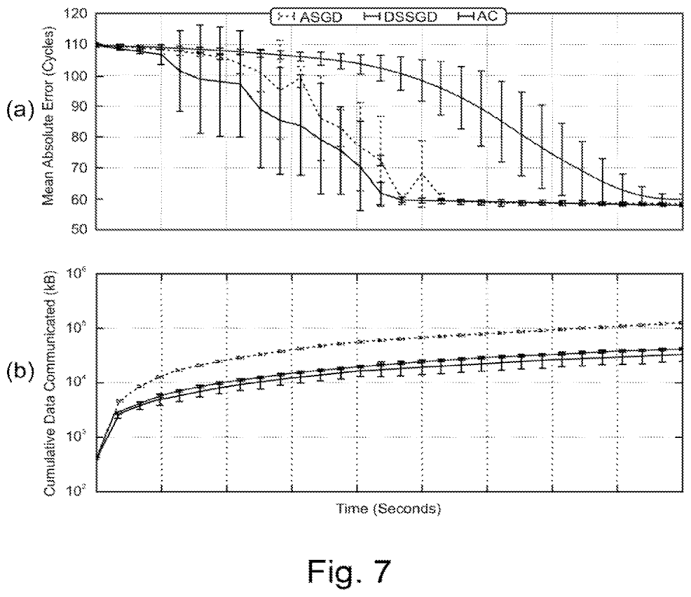

FIG. 8 shows the total data communicated, by each of ASGD, DSSGD and AC at different communication bandwidths, before converging to a stable model. Stability is defined as reaching a mean absolute error (MAE) of 60 Cycles. At a bandwidth of 80 kBps, DSSGD did not converge to a model of the required accuracy. As can be seen, the amount of data communicated for the AC system varies significantly, depending on bandwidth, as the AC system adapts to varying network capabilities. The AC system converges to a stable model with much less data communication than the other models for the 320 kBps and 80 kBps.

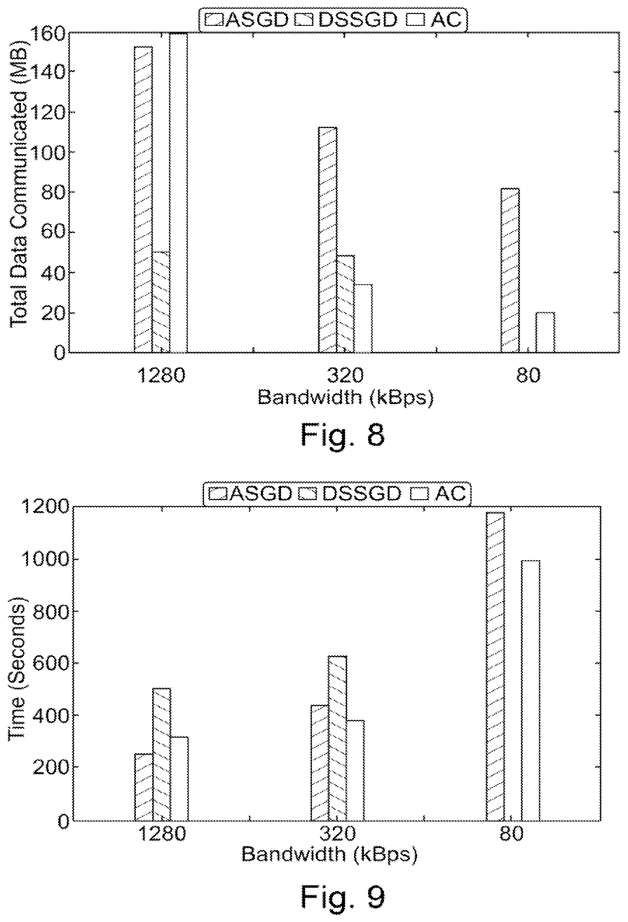

FIG. 9 shows the total time taken, by each of ASGD, DSSGD and AC at different communication bandwidths, before converging to a stable model. Again, this is defined as reaching an MAE of 60 Cycles. At a bandwidth of 80 kBps, DSSGD did not converge to a model of the required accuracy. AC converges to a stable model more quickly than the DSSGD system for all bandwidths and more quickly than the ASGD system in the 320 kBps and 80 kBps bandwidths.

The proposed training method, compared to the method of FIG. 3, considers operational factors in its functionality. An example of this, as stated above, could be observing the network quality. For instance, each update may include a parameter set whose size is at most that of the available bandwidth per second. This threshold can vary dependant on the feature to observe, such as model quality. Parameters that have changed the most between consecutive iterations are included first. This means there will be consistent training and a consistent number of updates within a given period.

If the update sizes are not varied, in cases of low network quality, update sizes may be too large to maintain consistent training. Conversely, if there is a strong network available, update sizes may be too small and may potentially miss out on valuable parameters that could be updated.

The present implementations varies update sizes throughout the training period based on the status of the model training and based on network quality. If the model is stable, fewer parameters are changing drastically, which leads to a smaller update size. This allows for a reduction in overall data communicated during training. Furthermore, where network quality is low, update sizes are reduced to avoid overloading the network and slowing down training.

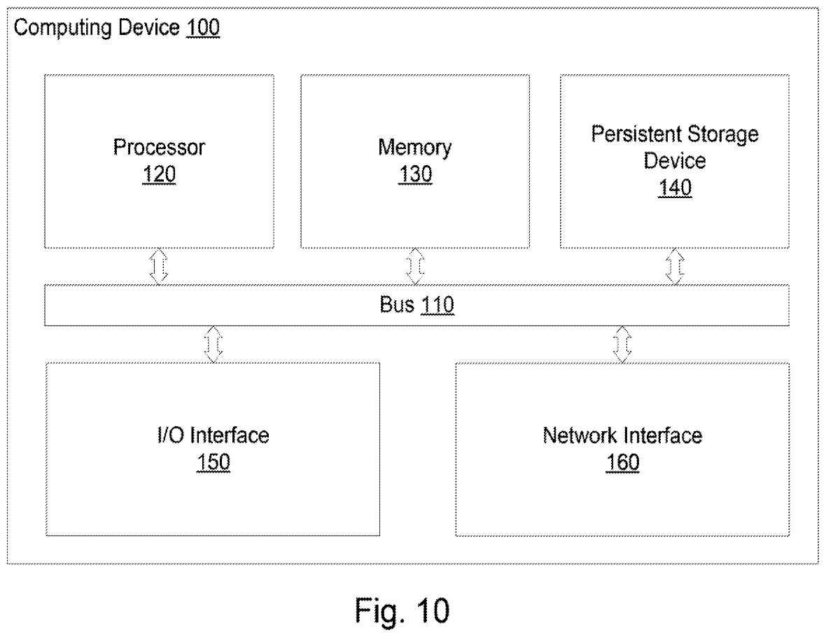

FIG. 10 shows a computing device 100 for putting the methods described herein into practice. The computing device 100 may be the server 10 or one of the workers 20.

The computing device 100 includes a bus 110, a processor 120, a memory 130, a persistent storage device 140, an Input/Output (I/O) interface 110, and a network interface 160.

The bus 110 interconnects the components of the computing device 100. The bus may be any circuitry suitable for interconnecting the components of the computing device 100. For example, where the computing device 100 is a desktop or laptop computer, the bus 110 may be an internal bus located on a computer motherboard of the computing device. As another example, where the computing device 100 is a smartphone or tablet, the bus 110 may be a global bus of a system on a chip (SoC).

The processor 120 is a processing device configured to perform computer-executable instructions loaded from the memory 130. Prior to and/or during the performance of computer-executable instructions, the processor may load computer-executable instructions over the bus from the memory 130 into one or more caches and/or one or more registers of the processor. The processor 120 may be a central processing unit with a suitable computer architecture, e.g. an x86-64 or ARM architecture. The processor 120 may include or alternatively be specialized hardware adapted for application-specific operations.

The memory 130 is configured to store instructions and data for utilization by the processor 120. The memory 130 may be a non-transitory volatile memory device, such as a random access memory (RAM) device. In response to one or more operations by the processor, instructions and/or data may be loaded into the memory 130 from the persistent storage device 140 over the bus, in preparation for one or more operations by the processor utilising these instructions and/or data.

The persistent storage device 140 is a non-transitory non-volatile storage device, such as a flash memory, a solid state disk (SSD), or a hard disk drive (HDD). A non-volatile storage device maintains data stored on the storage device after power has been lost. The persistent storage device 140 may have a significantly greater access latency and lower bandwidth than the memory 130, e.g. it may take significantly longer to read and write data to/from the persistent storage device 140 than to/from the memory 130. However, the persistent storage 140 may have a significantly greater storage capacity than the memory 130.

The I/O interface 150 facilitates connections between the computing device and external peripherals. The I/O interface 150 may receive signals from a given external peripheral, e.g. a keyboard or mouse, convert them into a format intelligible by the processor 120 and relay them onto the bus for processing by the processor 120. The I/O interface 150 may also receive signals from the processor 120 and/or data from the memory 130, convert them into a format intelligible by a given external peripheral, e.g. a printer or display, and relay them to the given external peripheral.

The network interface 160 facilitates connections between the computing device and one or more other computing devices over a network. For example, the network interface 160 may be an Ethernet network interface, a Wi-Fi network interface, or a cellular network interface.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of the inventions. Indeed, the novel methods and devices described herein may be embodied in a variety of other forms; furthermore, various omissions, substitutions and changes in the form of the methods and systems described herein may be made.

1. A computer-implemented method for training a machine learning model in a distributed system, the distributed system comprising a plurality of nodes that exchange updates to communally train the machine learning model, the method comprising a node:
receiving an update to a local model from one or more other nodes in the distributed system, the local model being a locally maintained version of the machine learning model and the update specifying a change to one or more parameters of the local model;
updating the local model based on the received update to determine an updated local model;
determining for each parameter in the local model a change in the parameter relative to a previous version of the local model; and
sending an update to the one or more other nodes in the distributed system, wherein the update includes an update to each parameter that has a change greater than a threshold.

2. The method of claim 1 further comprising:
monitoring a quality of service of a communication link between the node and the one or more other nodes; and
adjusting the threshold based on the quality of service.

3. The method of claim 2 wherein adjusting the threshold based on the quality of service comprises:
increasing the threshold in response to the quality of service increasing; and
decreasing the threshold in response to the quality of service decreasing.

4. The method of claim 3 wherein monitoring the quality of service comprises monitoring a throughput of the communication link and wherein the quality of service increases when the throughput increases and the quality of service decreases when the throughput decreases.

5. The method of claim 3 wherein the threshold is adjusted within a specified range that defines at least a maximum permissible threshold.

6. The method of claim 2 wherein adjusting the threshold based on the quality of service comprises adjusting the threshold to ensure a maximum transmission size for the update according to a current bandwidth of the communication link.

7. The method of claim 1 wherein the change is a percentage change relative to a previous version of the parameter.

8. The method of claim 1 wherein the plurality of nodes comprises a plurality of workers and a server, wherein:
each of the plurality of workers is configured to train a respective local model and report updates to the local model back to the server; and
the server is configured to aggregate updates from the workers to maintain a global model and report updates to the global model back to the workers.

9. The method of claim 6 wherein:
the node is a worker;
the update to the local model is received from the server and represents an update to the global model;
updating the local model comprises:
applying the update to the local model to bring the local model into compliance with the global model; and
training the local model based on training data to obtain the updated local model comprising updated parameters; and
the update is sent by the worker to the server for use in updating the global model.

10. The method of claim 6 wherein:
the node is the server and the local model maintained by the node is the global model that is locally maintained by the server;
receiving an update to a local model comprises receiving a plurality of updates from the plurality of workers, each update representing an update to a corresponding local model for the corresponding worker;
updating the local model comprises aggregating the updates from the plurality of workers to update the global model; and
the update is sent by the server to each of the workers for use in updating their respective local models.

11. The method of claim 10 further comprising the server periodically sending a full update of the global model representing the current state of every parameter of the global model to each of the workers.

12. The method of claim 11 wherein:
for each update that is sent by the server to a worker, the server determines whether to send a full update or an update including only those parameters that have changed by more than the threshold based on whether the worker has received a full update within a predefined period.

13. The method of claim 12 wherein the server implements a cyclic update strategy wherein each worker has a predefined allocation of full updates within each cycle.

14. The method of claim 13 wherein:
the predefined allocation is one; and
after a full update has been sent to a worker within a cycle, another full update is not sent until every other worker has received at least one full update within the cycle.

15. A node for use in a distributed system comprising a plurality of nodes that exchange updates to communally train a machine learning model, the node comprising:
storage configured to store a local model the local model being a locally maintained version of the machine learning model; and
a processor configured to:
receive an update to a local model from one or more other nodes in the distributed system, the local model being a locally maintained version of the machine learning model and the update specifying a change to one or more parameters of the local model;
update the local model based on the received update to determine an updated local model;
determine for each parameter in the local model a change in the parameter relative to a previous version of the local model; and
send an update to the one or more other nodes in the distributed system, wherein the update includes an update to each parameter that has a change greater than a threshold.

16. A non-transitory computer-readable medium comprising computer executable instructions that, when executed by a computer, configure the computer to act as a node within a distributed system, the distributed system comprising a plurality of nodes that exchange updates to communally train a machine learning model, the computer executable instructions causing the computer to:
receive an update to a local model from one or more other nodes in the distributed system, the local model being a locally maintained version of the machine learning model and the update specifying a change to one or more parameters of the local model;
update the local model based on the received update to determine an updated local model;
determine for each parameter in the local model a change in the parameter relative to a previous version of the local model; and
send an update to the one or more other nodes in the distributed system, wherein the update includes an update to each parameter that has a change greater than a threshold.
